(19) United States
(12) Patent Application Publication
(10) Pub. No.: US 2006/0284075 A1
(43) Pub. Date: Dec. 21, 2006

(54) NO-FRAGMENTATION MICRO MASS SPECTROMETER SYSTEM

(75) Inventors: Ulrich Bonne, Hopkins, MN (US); Nancy Iwamoto, Ramona, CA (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 11/276,311

(22) Filed: Feb. 23, 2006

Related U.S. Application Data
(60) Provisional application No. 60/657,350, filed on Feb. 28, 2005.

(51) Int. Cl. H01J 49/00

(52) U.S. Cl. 250/288

(57) ABSTRACT

A system for effecting a soft or gentle ionization technique to avoid fragmentation of analyte molecules provided to a micro mass spectrometer for analysis. To ionize the analyte molecules, the system may be based on proton transfer reaction (PTR) for ionization, UV light to generate either positive or negative ions, or E-field ionization. For example, with PRT, there may be a water generator for providing H₂O to an ion generator. H₃O⁺ may be provided by the generator to a charge transfer reactor that brings a stream of H₃O⁺ molecules together with analyte molecules. Then, H⁺ atoms may be transferred from the H₃O⁺ molecules to the analyte molecules without breaking up or fragmenting the respective analyte molecules. The ionized molecules may be provided to a micro mass spectrometer for analysis.

This application claims the benefit of U.S. Provisional Application No. 60/657,350, filed Feb. 28, 2005.

### BACKGROUND

The present invention pertains to material analyses and particularly it pertains to spectrometry. More particularly, it pertains to mass spectrometry of gaseous analytes.

### SUMMARY

The present invention system may ionize the analytes without fragmenting them for mass spectrometry in a micro mass spectrometer.

### BRIEF DESCRIPTION OF THE DRAWING

FIG. 1 is a block diagram of an illustrative example of a no-fragmentation of analyte for a micro mass spectrometer;

FIG. 2 is a block diagram showing soft ionization with charge transfer from water ions to the analyte;

FIG. 3 is a diagram of a more detailed illustrative example of a water ionization portion of the micro mass spectrometer system;

FIG. 4 is of an illustrative example of a water generator for supplying the water ionization portion of the micro mass spectrometer system;

FIG. 5 is a block diagram showing soft ionization via a vacuum ultra violet light source;

FIG. 6 is a more detailed diagram of the ultra violet light source soft ionization mechanism;

FIG. 7 is a block diagram showing soft ionization via an E-field;

FIG. 8 is a more detailed diagram of the E-field soft ionization mechanism;

FIG. 9 is a graph revealing the sensitivity of the no-fragmentation micro mass spectrometer relative to human breath; and

FIG. 10 is a graph revealing the sensitivity of the spectrometer relative to air quality VOC's.

### DESCRIPTION

Mass spectrometry has been haunted since its inception by the number of fragments each analyte molecule is broken into by excessive energies involved in traditional ionization processes, which are needed to operate mass spectrometers (MS) of any type (i.e., magnetic deflection, quadrupole, time-of-flight (TOF), ion-trap, and so on). The large number of fragments and the similarity masses resulting from the break-up of organic analyte mixtures makes mass spectra complex to interpret, requires special software, and results in less sensitivity than if all analytes remained intact except for an addition of a charge.

The PTR-MS (proton transfer reaction MS) may operate by using a charge transfer technique. Water in the sample gas or specially generated, such as ultra pure water, may be metered into an ion source to generate H₃O⁺ ions, which are then mixed with the air to be sampled. Pure water is used to avoid generating impure ions that may adhere to some of the sample molecules and thus obscure results of an MS analysis. Contaminants in the air with proton affinities higher than water may become protonated, and are then separated by mass and detected by the MS. Since most permanent gas components have low proton affinities, they do not interfere with the analysis, so that the only ions present are those of analytical interest. This gentle ionization technique may avoid fragmentation, so that each component is generally represented by a single ion with a mass one higher than its molecular weight, and detected at a higher signal-to-noise ratio (S/N) than it would be after fragmentation. The overall computational load and computer time of the MS may be significantly decreased without fragmentation.

This invention has its genesis in information provided by an acquisition of a PTR-MS. Features of the PTR-MS highlight a “gentle” ionization provided by the transfer reaction: Analyte+H₃O⁺>>Analyte H⁺+H₂O [1,2,3,4].

This may be an excellent way to overcome the challenge of ionizing analytes without fragmenting or dissociating them, in view of the fact that ionization energies are typically higher than dissociation energies. Very pure water to generate only H₃O⁺ ions is generally needed to avoid minimizing the generation of background ions; however, this may not be essential to enable the operation of a portable PTR-MS. The present system may incorporate the PTR-MS as an ionization approach for the ITMS (ion trap mass spectrometer).

In addition, a micro-generator of ultra pure water based on a selective approach may be noted in one of the following. One approach may include selective generation of H₂ from a LiAlH₄ source and the selective and controlled addition of O₂ via electrophoresis through a ZrO₂ micromembrane cell, and their subsequent reaction to H₂O on a simple Pt catalyst. However, the ionic transport of O⁼ through ZrO₂ requires temperatures of 700-800° C., i.e., relatively high “micropowers” to heat even small ZrO₂ membranes.

Another approach may include selective release of H₂O from a hygroscopic material such as P₂O₅ and LiCl (H₂O)ₙ. The controlled release would be effected by application of reversible forces of the above materials such as electric fields and heating a small area of a porous host material like Nanoglass™ to a temperature between an ambient temperature and 100° C., respectively.

A third approach may involve permeation from a small water reservoir separated from the H₃O⁺ generator by a low-permeability and/or porous wall or supported film, with controlled release of H₂O based on pulsed heating of that film.

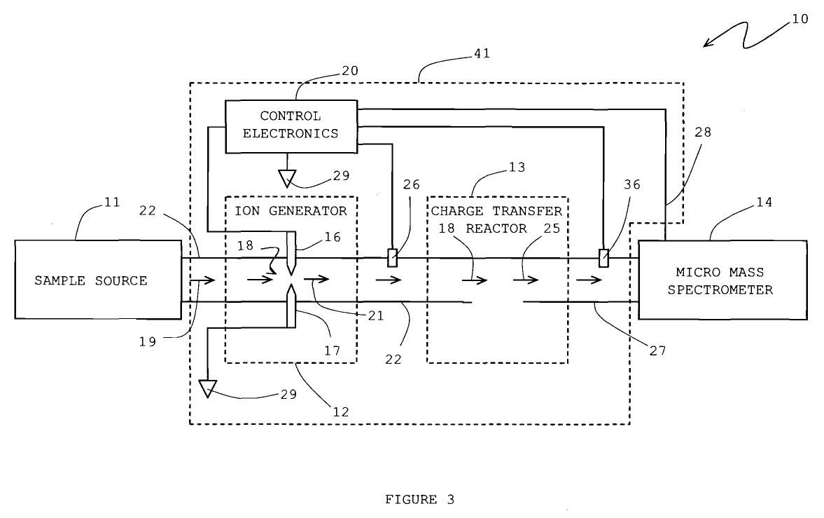

Still another approach may utilize water extraction from ambient air or from sample gas. The pure H₂O needed for H₃O⁺ generation needs to be provided at the reduced pressures that are required to operate the charge transfer reactor and the MS. This challenge may be met by either extracting H₂O from ambient air or the sample prior to its injection into the reactor, see FIG. 3, whereby H₂O transport to the generator is effected via condensation-in-small-pores, wicking and diffusion, which are made very selective and are being aided by the pressure gradient. To achieve a steady flow of H₂O despite changing ambient humidity, pulsed release of H₂O is adjusted by setting the film heater temperature pulse height to a level determined by the ambient humidity, which replenishes the film during the heater off-periods, such as during regular time intervals between analyses and during preconcentration.

Analyte solubility in water may entrain some of it into the H₃O⁺ generator and increase the steady background, but may become negligible relative to that of the injected sample provided by the pre-concentrator.

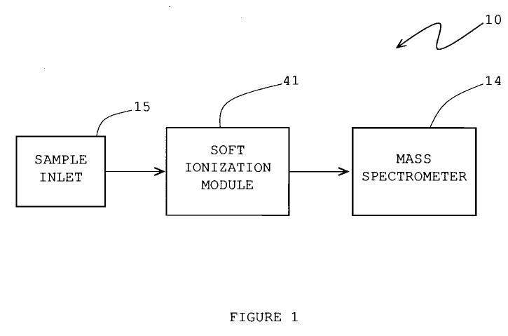

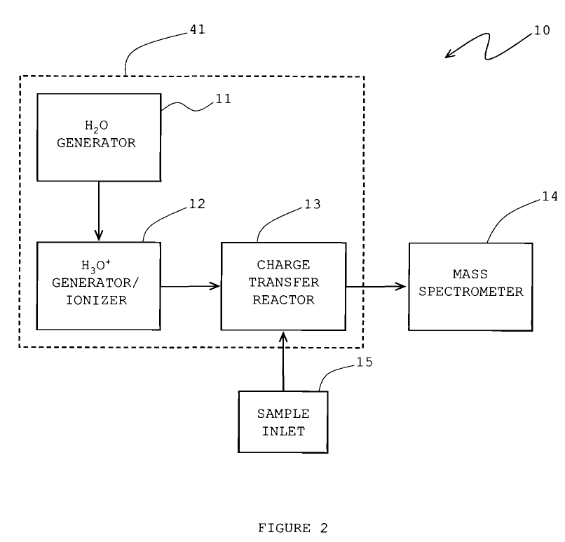

FIGS. 1 and 2 show an illustrative example of a non-fragmentation micro mass spectrometer system 10. An H₂O generator 11 may provide ultra pure water to an H₃O⁺ generator/ionizer 12. H₃O⁺ molecules may be provided from the generator ionizer 12 to a charge transfer reactor 13. Hydrogen ions may attach on a one-on-one basis to molecules from the sample inlet 15. These molecules take on a charge without any sort of fragmentation of the molecules. The molecules may go to the micro mass spectrometer 14 for an easy analysis since the molecules are still whole after being provided charges for tracking.

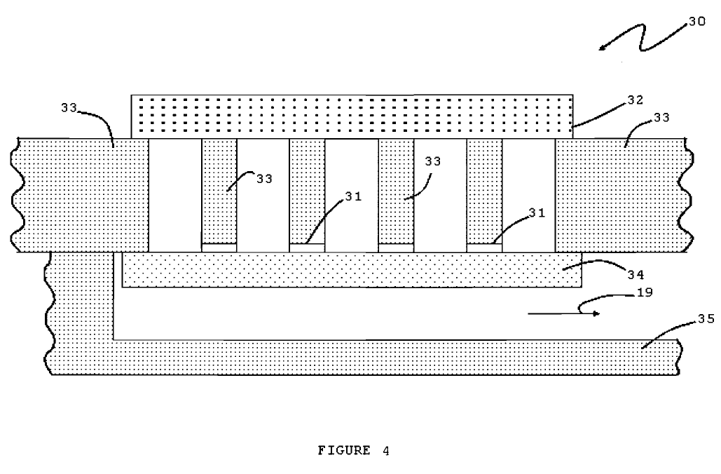

FIG. 3 is also a diagram of illustrative example of system 10 showing more details. The water ion generator may incorporate a water generator. The water generator may have a nanoporous material for water generation, which may be an example for a film 34 of FIG. 4. The nanoporous material may have pores and the pores may be treated with a humectant to maximize water condensation. Or the water generator 11, not necessarily incorporated within the ion generator, but as a separate entity may provide the virtually pure H₂O to the ion generator 12. FIG. 3 is not drawn relative to scale dimensionally but is made for illustrative purposes. The ion generator 12 may have a pair of electrodes 16 and 17. Electrode 16 may have a voltage applied relative to electrode 17 which is connected to ground or a voltage reference point 29. An arc may be formed at a gap 18 between the electrodes 16 and 17 to generate a gas discharge and ionize the H₂O molecules 19 into H₃O⁺ molecules 21. The width of gap 18 may be between 20 and 1000 microns. The voltage may be AC with a potential between 500 and 1000 volts. The voltage could be DC instead. Other forms of discharge may be utilized in lieu of electrodes 16 and 17. The voltage magnitude, duration and timing may be controlled by control electronics 20. Molecules 19 and 21 may flow through a channel 22 which has an inside diameter from about 0.1 millimeter to 1 millimeter. The H₃O⁺ molecules 21 may proceed as a stream through the channel 22 into the charge transfer reactor 13 where this stream meets up with a stream of sample molecules 23 via an inlet channel 24 from the sample source 15. At this junction of the streams of molecules 18 and 23, an H⁺ molecule from a molecule 18 may attach to a sample molecule 23 to result in a sample molecule 25 carrying a charge. There may be a by-product of water. Non-fragmented but charged molecules 25 may move on through the channel to the micro mass spectrometer 14 for analysis.

Charge detector 26 in channel 22 may monitor the amount of ionized molecules coming from the ion generator 12. The signals from detector 26 may go to control electronics 20 to assist in the control of the voltage across electrodes 16 and 17. There may be a charge detector 36 situated in channel 27 to monitor the molecules 27 entering the micro mass spectrometer 14. Detector may provide signals indicative of charge and/or count to control electronics 20. Also, there may be a connection 28 between control electronics 20 and spectrometer 14 for monitoring and control purposes. Spectrometer 14 may of a size such that it may fit on a micro chip or be an integrated-circuit like device. Various kinds of micro mass spectrometers 14 may be utilized in system 10.

FIG. 4 shows a design for an illustrative example of a pure water generator 30, which would not require replenishment of any consumables. Generator 30 may be used as the water generator 11 of system 10. Other kinds of water generators or sources (some of which are noted in the present description) may be utilized as the water generator 11 by system 10. Generator 30 may provide a controlled release of water via film heaters 31. There may be a particle filter 32 situated on a silicon film support heater wafer 33. Film heaters 31 may be situated at the bottom of portions 33 of the wafer. The wafer 33 and its portions may be situated on a hygroscopic and porous, H₂O-permeable film 34. The generated water molecules 19 may proceed from generator 30 through a channel formed by a channel wafer 35 and onto channel 22 of system 10.

If Nanoglass-E™ were used as the open-pore film, with its narrow pore size distribution near d=2 nm, the water vapor pressure inside the pores would be reduced (relative to normal ambient water vapor pressure, pₒ) by a factor given by the Kelvin equation, p/pₒ=exp{−4γM/(ρRTd)}. With γ=water surface tension=71.98 dyn/cm at 25° C., according to water data where M=18 g/mol for water, R=1.987 cal/mol=8.316·10⁷ dyn cm/mol Universal Gas Constant, 293≦T in K≦473; d=2·10⁻⁷ cm, and density ρ=1 g/cm³, one may get p/pₒ=exp(−4*71.98*18/1/8.316e7/293/2e−7)=0.345 to 0.517 for 20 to 200° C., respectively. This increased retention of water (due to the reduced water vapor pressure) and the incorporation in the pore surface of a humectant such as LiCl or LiBr insures water condensation, retention and temperature control of its (steady or pulsed) release.

Characteristics of the present mass spectrometer may include application of PRT ionization to the (micro) μITMS, and the generation of pure H₂O with means compatible with an associated micro gas analyzer, such as a battery-operated PHASED MGA and ITMS. These alternatives may provide the needed water. Further, E-field ionization may be applied to μITMS. Field ionization does not need generation of H₃O⁺ to generate analyte ions, but may need MEMS (micro-electro-mechanical system) structures (cones or needles) to generate the high fields. U.S. Pat. No. 6,393,894, issued May 28, 2002, herein incorporated by reference, may disclose PHASED devices. U.S. patent application Ser. No. 10/829,763, filed Apr. 21, 2004, herein incorporated by reference, may disclose PHASED devices. U.S. patent application Ser. No. 10/909,071, filed Jul. 30, 2004, herein incorporated by reference, may disclose PHASED devices.

Advantages of above the ionizers and mass spectrometers over the related art ones may include an ability to operate with portable microanalyzers and especially with micro-ITMSs (which are goaled to operate at up to 0.1 bar of sample pressure inlet), and a design of a compact, low-power, low-cost water generator to provide “pure” water to the H₃O⁺ generator, which ideally (see FIG. 4) should not require any replenishment of consumables. Additionally, non-fragmentation ionization makes the MS more sensitive (lower MDL) and analyte identification easier, except in the few cases when ion-masses overlap as in N₂ and CO.

There may be available a field-deployable proton transfer reaction mass spectrometer (PTR-MS) which is capable of real-time, online quantification of volatile organic compounds in air. The instrument provides an extremely fast response time of about one second, and detection limits for a one-second integration time range from 50 pptv to about 300 pptv, depending on the nature of the analyte.

Gentile or soft ionization means the ionizing of molecules with no or virtually no fragmentation, or with merely negligible or insignificant fragmentation, for mass spectrometry measurement purposes. Organic species may be measured using chemical ionization mass spectrometry. H₃O⁺ is used as the reagent ion and results in a soft (gentle) ionization of most organic species with negligible fragmentation. The air sample is continuously drawn into a reaction chamber where it encounters the reagent ion. Organic species having a proton affinity greater than that of H₂O will react with H₃O⁺ in a proton transfer reaction:
R+H₃O⁺→RH⁺+H₂O

The major constituents of air do not react with H₃O⁺. A small portion of the flow through the reaction chamber is sampled by a quadrupole mass spectrometer where the RH⁺ ions are mass filtered and detected by an ion multiplier. The amount of analyte (R) in the sample air is determined by a simple formula relating the H₃O⁺ count rate, the RH⁺ count rate, the rate constant for the ion-molecule reaction, and a fixed reaction time. The rate constants for many of these reactions are known, but can also be calculated from theory.

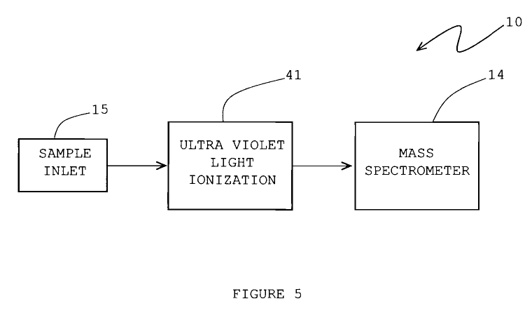

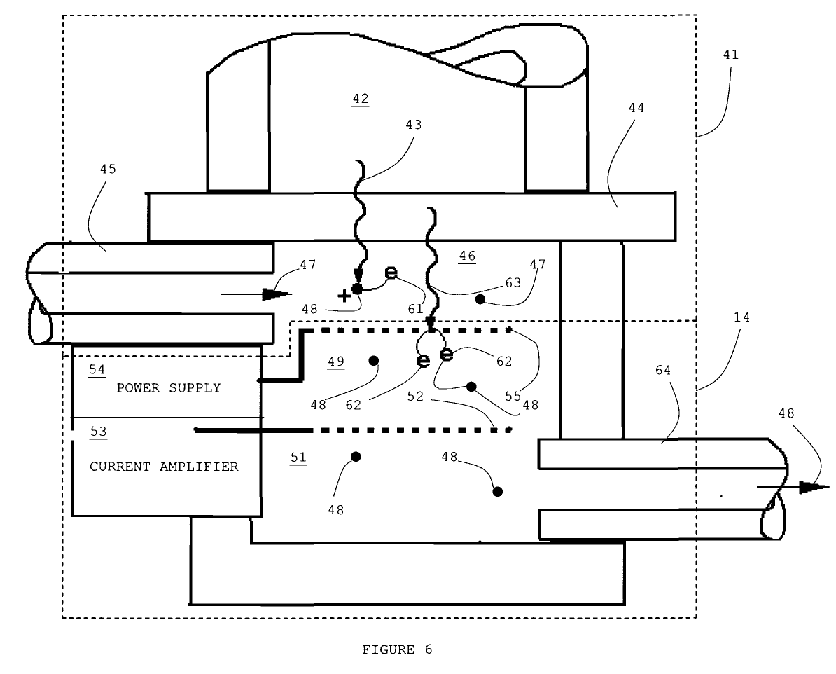

FIG. 5 is a block diagram of another illustrative example of a soft ionization module 41, which is a vacuum ultra violet (VUV) light source 42 for ionizing molecules to be analyzed by the micro mass spectrometer 14. The soft ionization module 41 may have an array of different soft ionizing sources. FIG. 6 reveals more detail of the VUV 42 for ionization of analytes 47 directly by removal of electrons 61 or indirectly via a capture of photo electrons 62. The VUV light 43 or 63, respectively, may emanate from a source 42 through a VUV window 44. The light 43 may be of up to 12 eV through an LiF window 44 or light 63 may be of up to 10.6 eV through an MgF₂ window 44. The light source 42 may be, for example, a light discharge lamp from Baseline-MOCON, Inc.

A sample 47 may come in through a channel 45 into a chamber 46 of module 41. The channel 45 may be about 150 by 150 microns in size. The sample may be from a micro gas chromatograph (GC) or another source. The light may impinge the sample or analyte molecules 47 and knock off electrons from them or alternatively generate photo electrons from an electrode 55 for capture by the molecules to result in soft ionization with out fragmentation of the molecules 48. The ionized molecules 48 may be in an ion trap 49 of the mass spectrometer 14 and then pass through an ion detection grid 52 in a Faraday cage 51. A current is generated in the grid or element 52 due to the detection of the ionized molecules 48. The current may be amplified by a current amplifier 53 which may output a signal to be processed to determine information about the molecules 48.

Power supply 54 may provide a voltage to grid or electrode 55, which may include a ring electrode and/or other electrodes to provide a quadrupole E-field array under the top electrode 55. The pressure within the device, such as cage 51, may range from about 0.001 to 1 bar. Analyte molecules 48 may be pumped out via a channel 64. Channel 64 may have dimensions similar to those of channel 45.

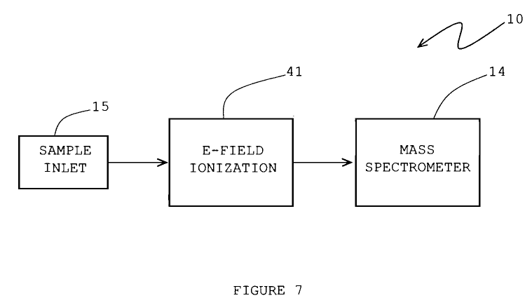

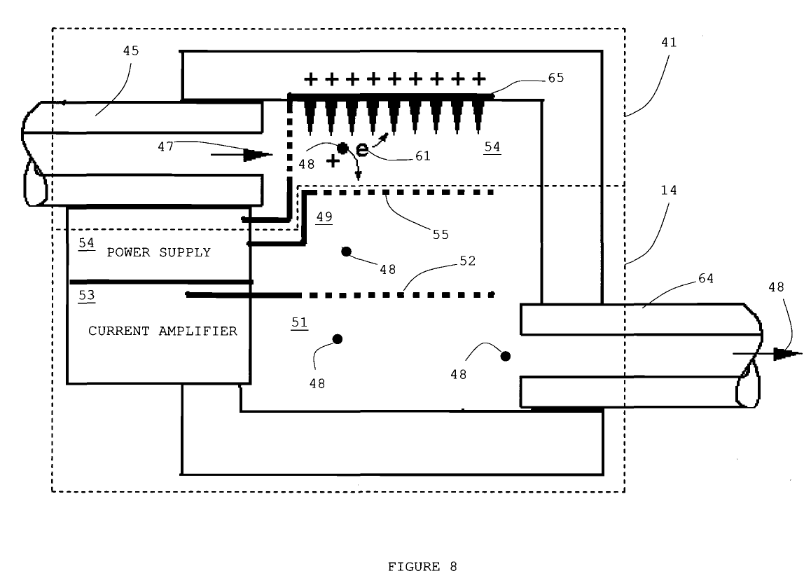

FIG. 7 is a block diagram of a soft ionization module 41 having a device for E-field ionization. FIG. 8 reveals more details of the field ionization device 65. A sample or analyte of molecules 47 may come in through the channel 45 in through the chamber 54 of module 41. The molecules 47 may be directly ionized by an E-field into ions 48. The E-field ionization may be effected by a positive electrode 65 that attracts electrons 61 from the molecules 47. E-field ionization may be superior to the E-beam ionization in situations where it is best not to fragment the molecules 47 upon ionization. The resulting non-fragmented ions 48 here may be pulled into the ion trap 49 of the mass spectrometer 14. The remaining aspects of micro spectrometer 14 may be similar to those of spectrometer 14 of FIG. 6.

Other kinds of mechanisms and approaches for soft ionization may be used for mass spectrometer applications, and particularly micro mass spectrometers.

The incorporation of an array of soft ionization modules may improve the probability of obtaining the ionized molecule or analyte depending upon its chemistry. For instance, those molecules with higher nucleophilicity may ionize more readily using the H₃O⁺ generator/ionizer or may more readily lose an electron using the soft E field ionization or using VUV ionization. Or those molecules that are more electrophilic may ionize more easily via photoelectron capture using VUV ionization. Because the molecules may be additionally separated based upon the type of chemistry they may prefer, the identification of the molecule becomes improved. And because of how molecules can be classified based upon their chemistry, the different soft ionization modules to be used (array, or partial array) may be chosen based upon the expected analyte environment of interest.

The PTR-MS may be suited for performing fast real-time measurements of particular species that are known to be present in a mixture or that have unique masses in order to study a rapidly evolving temporal process. The instrument may be built into an aerospace grade rack and flown on a research aircraft to collect measurements of urban air pollution. The figure below illustrates its measurement capability. The PTR-MS is an enabling technology that will allow in situ studies of the fate and transformation of organic matter in the atmosphere not previously possible with older technologies.

Under the Clean Air Act, the U.S. Environmental Protection Agency has identified twenty one chemical compounds as mobile source air toxics. Because no on-vehicle, real-time method exists for determination of these compounds in motor vehicle engine exhaust, there is an opportunity for application of a miniature mass spectrometer (MMS) used in conjunction with a proton transfer reaction (PTR) inlet/ionization source to address this problem. An analytical instrument package including sample inlet, PTR ionization source, and control/data acquisition software for use with the miniature cylindrical ion trap mass spectrometer and deliver a detailed design of a beta-version prototype may be achieved. This may result in an on-vehicle MMS-based instrument system housed in a rugged package, with direct gas-phase sample inlet port(s) and robust software for instrument control and data acquisition/manipulation.

Critical components of the PTR-MMS system may include technical features and analytical performance in such areas as reproducibility, sensitivity, sampling frequency, and limit(s) of detection. The majority of the compounds listed as mobile source air toxics may be known to have proton affinities that make them amenable to ionization via proton transfer reaction, resulting in sensitive and selective detection through the present combination of PTR inlet/ionization source and MMS.

The use of commercial components requiring some modifications may provide the basis for the various structures throughout the inlet/ionization source system. Components of the system may include tubing and fittings capable of maintaining reduced pressures that assemble in a standard modular fashion. For proper operation of the flow drift tube portion of the inlet/ionization source, additional pumping may be required at the PTR/MMS interface region to maintain the necessary sample flow rate at a sufficiently reduced pressure. A pumping system consisting of a rugged turbo pump with a backing pump in the form of a diaphragm pump has been identified that will maintain a relatively small overall instrument size for on-vehicle applications. One may note that the addition of this pumping system may significantly increase the power requirements for the entire PTR-MMS instrument. This may require additional power in the form of batteries to be carried with the instrument during operation, particularly during startup when the power draw of the instrument, specifically the pumps, is highest.

Both laboratory experiments and computer simulations may be conducted to evaluate the design of PTR system components. Specific tests were conducted to evaluate the discharge ion source within the proposed PTR setup. Although not identical to the present hollow cathode discharge source, the glow discharge arrangement tested as part of an evaluation provided valuable insight as to the ion production and transport efficiencies of the instrument. It was found that the discharge may produce copious amounts of ions that subsequently are transported to the analyzer with reasonable efficiency. The electric fields generated within the flow drift tube portion of the inlet/ionization source may be modeled in silico, and under operating conditions, reactant and product ions may be effectively delivered from the source to the ion optics and, subsequently, the analyzer. Based on these factors, the present system for the PTR system components may provide good analytical performance, which may be further optimized through testing/refinement of the prototype instrument.

Software is another significant aspect of the present system for instrument control/data acquisition for use with the PTR-MMS instrument. The instrument user may control the instrument by means of a Microsoft Windows™-based graphical user interface. The user may adjust voltages, calculate and apply waveforms to the ion trap, and set timing events such as gating of ions, switching of valves, and so forth. Mass spectral data that are acquired may be displayed in real time or in a user-defined averaged mode. The total ion chromatogram information (i.e., the total signal at the detector) may also be acquired and displayed. Data being displayed in any or all of these formats may be saved at any time during an analysis (data manipulation is another significant component of a software package). A calibration routine may also be included that allows for mass calibration. The combination of a powerful but yet intuitive instrument control interface, data display, and data manipulation window may make the PTR-MMS instrument a useful analytical tool.

Overall, the instrument components may allow for a relatively small instrument footprint with commercial applications in other areas that can benefit from rugged, miniaturized instrumentation. Significant commercial applications may exist in the areas of air quality monitoring, respiratory toxicology, process monitoring, and homeland defense in which qualitative and/or quantitative chemical information is needed at the point of sample collection. Because many applications for miniaturized, real-time analyses exist, a commercialization of MMS-based instrumentation, including the PTR-MMS system, may be attractive to pursue. A significant commercial objective may be to develop sample introduction/ionization techniques that when used in conjunction with the MMS may provide in-situ solutions to a wide range of analytical problems. The present PTR system represents a major step forward in this direction.

It was found that the combination of the present PTR inlet/ionization source and MMS instrument may represent an approach to monitoring the mobile source air toxics in engine exhaust. One area to note is the power requirements of the pumping system (e.g., turbo pump and backing pump) connected to the flow drift tube portion of the PTR system. Here, the power requirements may be mitigated by the fact that the PTR-MMS system is not necessarily intended to be operated as a portable (i.e., carried by an operator) instrument, rather as a vehicle-based sampling platform for real-time monitoring of components of engine exhaust.

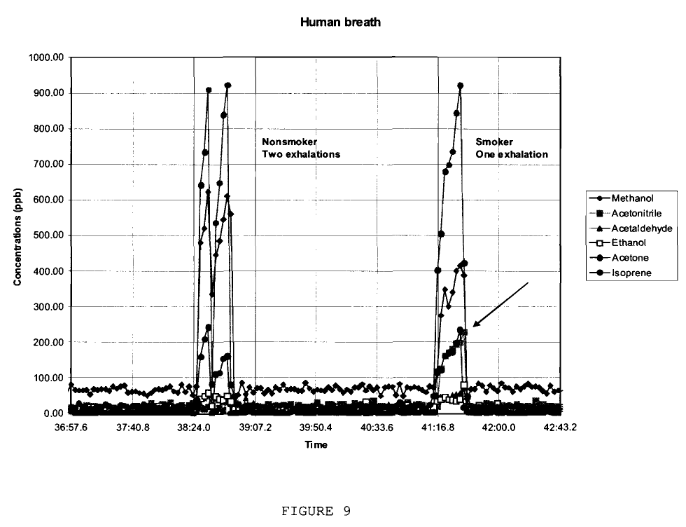

FIG. 9 shows an example of a PTR-MS scan vs. time of human breath components in the ppb range, with sub-second time resolution. It shows PTR-MS system capabilities with a graph of concentration vs. time of lab air, with analysis of breath components provided by individuals, who exhaled near the instrumental probe. Peaks for acetone, methanol and isoprene appear immediately and are typical bio-effluents found in human breath. One of the individuals is a smoker, so the system also detects some acetonitrile, a metabolic byproduct of nicotine, which lingers in his system since use of the last cigarette.

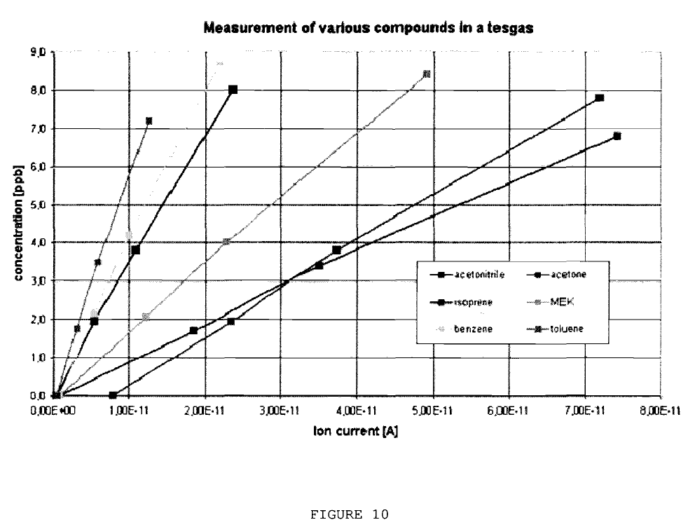

FIG. 10 shows the sensitivity to air-quality affecting volatile organic compounds (VOC's) and ion current for the PTRS-MS system with a detection limit of 1 ppbv. This Figure shows ppb vs. ion-current calibration curves the PTR-MS for acetonitrile, isoprene, benzene, MEK, acetone and toluene. For such measurements, a fully computer controlled instrument may have technical specifications that include a weight of about 55 kg, a size of about 55 cm×44 cm×60 cm, a data communication Ethernet (LAN and Internet), operation with full remote control via a PC, power consumption of approximately 300 watts, a mass range of 0-200, a measuring time of 10-60 000 ms/amu, a response time<200 ms, and a heating of a reaction chamber up to 80° C. and of an inlet up to 150° C.

In the present specification, some of the matter may be of a hypothetical or prophetic nature although stated in another manner or tense.

Although the invention has been described with respect to at least one illustrative example, many variations and modifications will become apparent to those skilled in the art upon reading the present specification. It is therefore the intention that the appended claims be interpreted as broadly as possible in view of the prior art to include all such variations and modifications.

What is claimed is:

1. A mass analyzer comprising:
a sample source;
a soft ionization module; and
a spectrometer connected to the soft ionization module.

2. The analyzer of claim 1, wherein the spectrometer is a micro mass spectrometer.

3. The analyzer of claim 2, wherein the soft ionization module is a vacuum ultraviolet (VUV) light source ionizer.

4. The analyzer of claim 3, wherein the vacuum ultraviolet (VUV) light source ionizer generates ions by VUV direct ionizing of analyte molecules from a fluid of the sample source.

5. The analyzer of claim 2, wherein the soft ionization module is an E-field ionizer.

6. The analyzer of claim 5, the E-field ionizer generates ions via field ionization of analyte molecules from the fluid of the sample source.

7. The analyzer of claim 2, wherein the soft ionization module comprises:
a charge transfer reactor; and
a water ion generator connected to the charge transfer reactor.

8. The analyzer of claim 7, wherein:
the water ion generator comprises several electrodes having a voltage; and
water is passed through the electrodes to generate water ions.

9. The analyzer of claim 8, wherein the charge transfer reactor is for transferring charges of the water ions to the molecules of a sample virtually without fragmentation of the molecules.

10. The analyzer of claim 7, wherein the water ion generator comprises a water generator.

11. The analyzer of claim 10, wherein the water generator comprises a nanoporous material for water generation.

12. The analyzer of claim 11, wherein:
the nanoporous material comprises pores; and
the pores are treated with a humectant to maximize water condensation.

13. The analyzer of claim 1, wherein the soft ionization module comprises an array of different soft ionizing sources.

14. A method for mass spectrometry comprising:
providing carriers of ion charges;
transferring ion charges to molecules of a sample; and
measuring the masses of the molecules with a micro mass spectrometer.

15. The method of claim 14, wherein the molecules of the sample being measured by the micro mass spectrometer are generally not fragmented.

16. A method of mass spectrometry comprising:
providing a VUV source to generate ions from analyte molecules; and
measuring the ions; and
wherein:
the VUV source provides high energy photons to knock off electrons from the analyte molecules; and
the analyte molecules are virtually not fragmented

17. A method of mass spectrometry comprising:
providing a VUV source to generate photo-electrons from an irradiated metal surface;
providing analyte molecules; and
measuring ionized analyte molecules; and
wherein:
the analyte molecules are ionized by their capture of the photo-electrons; and
the ionized analyte molecules are virtually not fragmented

18. A method of mass spectrometry comprising:
providing an E-field in the a path of analyte molecules; and
measuring ions; and
wherein:
the E-field pulls electrons off the analyte molecules resulting in ions; and
the ions are virtually not fragmented

19. The method of claim 18, wherein the measuring ions is performed by a micro mass spectrometer.

20. The method of claim 19, wherein the micro mass spectrometer is situated on a micro chip.

21. A system for mass measurement comprising:
a charge generator;
a charge transfer reactor connected to the charge generator; and
a mass spectrometer connected to the charge transfer reactor; and
wherein the charge transfer reactor is for attaching charges to molecules of a sample without fragmenting the molecules.

22. The system of claim 21, wherein the mass spectrometer is a micro mass spectrometer of about a size of a micro chip.

23. The system of claim 22, further comprising a water source connected to the charge generator.

24. The system of claim 23, wherein:
the charge generator provides H₃O⁺ molecules to the charge transfer reactor; and
charges provided for attachment to the molecules are hydrogen atoms.
